(19) United States
(12) Patent Application Publication
(10) Pub. No.: US 2026/0274441 A1
(43) Pub. Date: Sep. 17, 2026

(54) METHOD AND SYSTEM FOR DETERMINING A FAULTY COMPONENT OF AN AIRCRAFT

(71) Applicant: SAFRAN AIRCRAFT ENGINES, Paris (FR)

(72) Inventors: Francis Antoine Christophe DELANGUE, Moissy-Cramayel (FR); Heidi Sarah BRATHIER, Moissy-Cramayel (FR); Kévin Pierre Jean GALLI, Moissy-Cramayel (FR); Mathias GAUTIER, Moissy-Cramayel (FR); Armand Dariouche ALIMARDANI, Moissy-Cramayel (FR); Francois Maurice Marcel DEMAISON, Moissy-Cramayel (FR)

(73) Assignee: SAFRAN AIRCRAFT ENGINES, Paris (FR)

(21) Appl. No.: 19/469,569

(22) PCT Filed: Mar. 29, 2024
(86) PCT No.: PCT/FR2024/050417

§ 371 Date: Sep. 26, 2025

(30) Foreign Application Priority Data
Mar. 29, 2023 (FR) FR2303032

(51) Int. Cl. B64F 5/60; G06N 7/01; G07C 5/08

(52) U.S. Cl. CPC B64F 5/60; G06N 7/01; G07C 5/0808; G07C 5/0816

(57) ABSTRACT

A digital system for determining at least one faulty component of an aircraft including: a first module for determining at least one first symptom of the aircraft from status data collected on-wing; a second module for determining at least one second symptom of the aircraft from degradation data representative of an abnormal variation in flight data; a module for determining failure probabilities of a plurality of aircraft components on the basis of the at least one first and second symptoms, the module including a Bayesian network trained using a knowledge base including data produced by a natural language processing module configured to process aircraft maintenance reports, a module configured to signal at least one faulty component among the plurality of components as a function of said probabilities.

### PRIOR ART

The present invention relates to the general field of aeronautics.

More specifically, it concerns a method and a decision support system for identifying faulty components on an aircraft.

An aircraft can be considered as a complex system made up of a certain number of hardware and software components (computer, sensors, etc.), all of which are liable to fail.

When a fault is suspected, it is common for an operator to move in the vicinity of the aircraft (also known as “on-wing”) to carry out tests to try to determine the faulty component or components causing the fault.

In practice, the on-wing operator follows a diagnostic scenario comprising a linear list of instructions, presented for example in the form of a fault-finding flowchart in a maintenance document, in paper or digital form. These maintenance documents have a very long update cycle, and are published around twice a year.

When the operator suspects that one or more components are faulty, he removes these components and sends them to a repair workshop for a more in-depth analysis, using industrial testing resources.

In order to work quickly or because of inadequate training, the on-wing operator often removes an excessive number of components. Furthermore, during the workshop analysis phase, it may turn out that the components assumed to have failed are not the real cause of the fault and have therefore been wrongly removed.

For example, an on-wing operator may assume that a sensor is faulty, remove this sensor and send it to the workshop for repair. When the supposedly faulty sensor is analysed in the workshop, it may be determined that the sensor is operating normally and that the real cause of the fault is in fact an electronic board configured to process the data measured by the sensor*.

A maintenance report is then drawn up, this report comprising, for example, alert messages or fault alarms, of the results of measurements made by the on-wing operator or by the repairer in the workshop, symptoms detected by the on-wing operator or by the repairer, the components determined to be faulty and the actual cause of the fault determined after analysis. This maintenance report may be digital, for example.

In the aerospace industry in particular, there is a reliability indicator known as No Fault Found (NFF), which represents a rate of unscheduled and unjustified removals calculated from the ratio of the Mean Time Between Unscheduled Removal (MTBUR) and the net mean time between unscheduled justified removals known as the Mean Time Between Failure (MTBF). These indicators comply with the following equation:

$$MTBUR = ( 1 - NFF ) \cdot MTBF .$$

It is known that the cost of these unscheduled removals NFF is very high and has a major impact on airline operating costs.

The invention aims to alleviate at least some of these drawbacks by proposing a fault determination system that enables the on-wing operator to better identify the actual cause of an aircraft failure, and consequently the component or components to be removed, so as, in particular, to improve the NFF reliability indicator.

### DISCLOSURE OF THE INVENTION

The present invention responds, in particular, to this need by proposing a digital system for determining at least one faulty component of an aircraft, said system comprising:
an aircraft fault information module;
a first module for determining at least one first symptom of the aircraft from status data collected on-wing;
a second module for determining at least one second symptom of the aircraft from degradation data representative of an abnormal variation in flight data;
a module for determining failure probabilities of a plurality of aircraft components on the basis of said at least one first and second symptoms, said module comprising a Bayesian network trained using a knowledge base comprising data produced by a natural language processing module configured to process aircraft maintenance reports,
a module configured to signal at least one faulty component among said plurality of components as a function of said probabilities.

Correspondingly, the invention relates to a method of determining at least one faulty component of an aircraft, this computer-implemented method comprising the following steps:
obtaining information about an aircraft fault;
determining at least one first aircraft symptom from status data collected on-wing;
determining at least one second aircraft symptom from degradation data representative of an abnormal variation in flight data;
determining failure probabilities of a plurality of components of the aircraft on the basis of said at least one first and second symptoms, this determination using a Bayesian network trained using a knowledge base comprising data produced by a natural language processing module configured to process aircraft maintenance reports,
signalling at least one faulty component among said plurality of components as a function of said probabilities.

In this way, and highly advantageously, the digital system determines faulty components using both “status data” and “degradation data”.

The status data represents a status of the aircraft. This data can be collected by an operator (or by a robot), for example with measuring equipment, operating in the vicinity of the aircraft, i.e. “on-wing”. For example, the data are returned by a man-machine interface via alarms or fault messages. They can sometimes be determined directly or observed by the operator, when he detects a noise or smell characteristic of a malfunction.

By contrast, degradation data, or behaviour data, are data that represent a trend, or an abnormal variation in flight data. They can be determined, for example:
when flight data changes and exceeds a threshold;
when the one signature of a series of flight data is representative of a degradation in the operation of the aircraft;
by continuously processing flight data.

Unlike status data, these degradation data are difficult for the operator to access. They do, however, provide a wealth of information and taking them into account makes it possible to overcome the limits to knowledge concerning modelling the physical phenomena that cause failures.

Very advantageously, both the status data and the behaviour data are used to determine symptoms (first and second symptom in the context of the invention) which are processed in the same way by the module for determining component failure probabilities.

Furthermore, and highly advantageously, the determination of aircraft component failure probabilities uses a Bayesian network trained using a knowledge base comprising data produced by a natural language processing module configured to process aircraft maintenance reports.

Taking into account behaviour data to determine aircraft symptoms and feedback from experience in the Bayesian network improves the modelling of physical phenomena and, consequently, the modelling of degradation phenomena.

The system and the determination method thus enable the diagnosis leading to the identification of the components which are the actual causes of failure to be improved and, consequently, enable the direct and indirect costs associated with an incorrect fault-finding diagnosis during aircraft maintenance on the ground to be reduced.

The invention thus enables the detectability of faults in systems and their equipment to be improved, and enables the aircraft to be got back into service more quickly and therefore enables unscheduled operational downtime to be reduced.

In one embodiment, said at least one second symptom is a signature determined from one or more indicators that are set when the second determination module detects behaviour data representative of a degradation trend in the operation of at least one component of the aircraft.

For example, a signature may be determined from an indicator representative of a degradation of a first component and an indicator representative of a degradation of a second component, these components possibly being included in different sub-systems of the aircraft.

Advantageously, this embodiment enables the modelling of symptoms resulting from interactions between aircraft subsystems, even when these interactions are difficult to understand or model. For example, the mechanical vibrations of a rotating assembly can generate vibrations and damage equipment in another system that is not directly linked to the rotating system.

The invention also relates to a method and device for training a Bayesian network that can be used in a system in accordance with the invention.

Thus, and according to a second aspect, the invention also relates to a method for training a Bayesian network intended to be implemented by a module configured to determine failure probabilities of a plurality of components of an aircraft on the basis of at least one first and at least one second symptom of the aircraft, said Bayesian network being trained using a knowledge base comprising data produced by a natural language processing module configured to process aircraft maintenance reports, wherein:
said at least one first symptom of the aircraft is determined from status data collected on-wing; and
said at least one second symptom of the aircraft is determined from degradation data representative of an abnormal variation in flight data.

Correspondingly, the invention also relates to a device for training a Bayesian network intended to be implemented by a module configured to determine failure probabilities of a plurality of components of an aircraft on the basis of at least one first and second symptom of the aircraft, said Bayesian network being trained using a knowledge base comprising data produced by a natural language processing module configured to process aircraft maintenance reports, wherein:
said at least one first symptom of the aircraft is determined from status data collected on-wing; and
said at least one second symptom of the aircraft is determined from degradation data representative of an abnormal variation in flight data.

In a particular embodiment, the natural language processing module used in the invention is a module of the training device.

In one embodiment, this natural language processing module takes, as input, texts extracted from aircraft maintenance reports and produces, as output, labels which constitute structured information used by an enhancement module to enhance the knowledge base.

In one embodiment of the invention, the knowledge base comprises records that associate symptoms with failures. The natural language processing module produces:
(i) at least one first label representing at least on piece of information concerning flight data, status data, behaviour data and/or symptoms; and
(ii) at least one second label representing a failure.

In one embodiment, the knowledge base enhancement module is configured to enhance the knowledge base with at least one record comprising:
(i) at least one symptom identified from a first label, combined with
(ii) a failure identified from a second label.

In a particular embodiment, the various steps in the method for determining faulty components and the main steps in the method for training the Bayesian network are determined by computer program instructions.

Consequently, the invention also relates to a computer program on a storage medium, this program being capable of being implemented in a computer, this program comprising instructions suitable for implementing the steps of a method as described above.

This program can use any programming language, and be in the form of source code, object code, or code that is intermediate between source code and object code, such as in a partially compiled form, or in any other desirable form.

The invention also relates to a computer-readable storage medium comprising instructions for a computer program as mentioned above.

The storage medium can be any entity or device capable of storing the program. For example, the medium may comprise storage means, such as a ROM, for example a CD ROM or a microelectronic circuit ROM, or even a magnetic recording means, for example a hard drive.

On the other hand, the storage medium may be a transmissible medium such as an optical or electrical signal, which can be routed via an electrical or optical cable, by radio or by other means. In particular, the program according to the invention can be downloaded on an Internet-type network.

Alternatively, the storage medium may be an integrated circuit in which the program is incorporated, the circuit being suitable for executing or for being used in the execution of the method in question.

### BRIEF DESCRIPTION OF THE DRAWINGS

Other features and advantages of the present invention will become apparent from the description given below, with reference to the appended drawings which illustrate an exemplary embodiment that is in no way limiting. In the figures:

FIG. 1 shows a system for determining faulty components in accordance with the invention;

FIG. 2 shows the hardware architecture of a terminal in accordance with a particular embodiment of the invention;

FIG. 3 shows the hardware architecture of a training device in accordance with a particular embodiment of the invention;

FIG. 4 shows, in the form of a flowchart, the main steps of a training method in accordance with the invention; and

FIG. 5 shows, in the form of a flowchart, the main steps in a method for determining faulty components, in accordance with the invention.

### DETAILED DESCRIPTION OF THE EMBODIMENTS

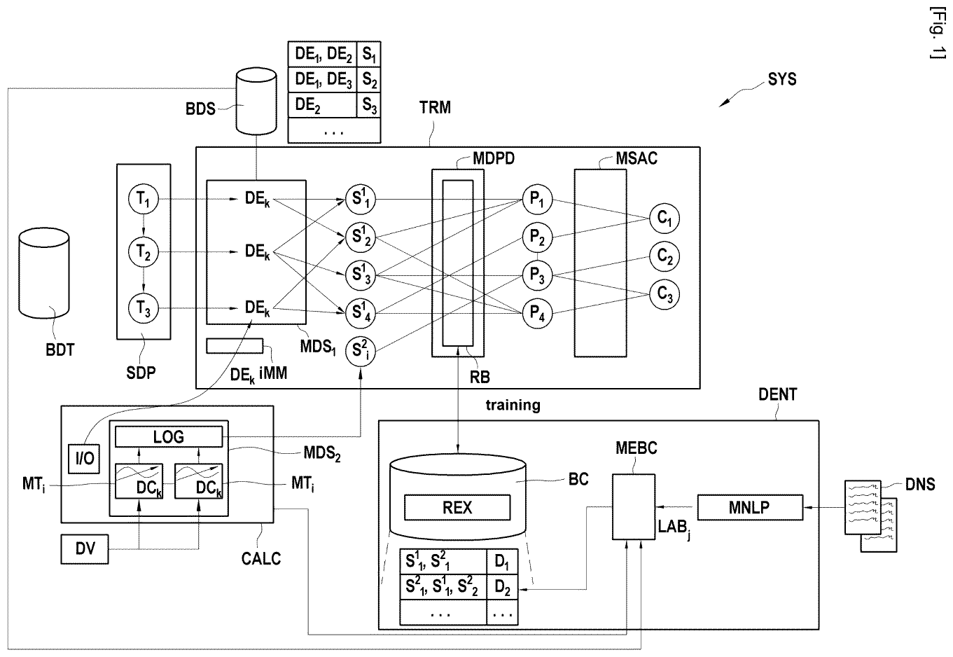

FIG. 1 shows a digital system SYS for determining faulty components, in accordance with one embodiment of the invention.

This system comprises a first module MDS₁ for determining first symptoms.

When an aircraft problem or failure is suspected, an operator moves in the vicinity of the aircraft (or “on-wing”) and performs a number of tests in order to obtain aircraft status data DEₖ, and deduce first symptoms S¹ᵢ using this first MDS₁ module for the determination of symptoms.

In practice, the first module MDS₁ for symptom determination may be a module incorporated in a terminal TRM of the operator OP. In the embodiment of FIG. 1, the terminal TRM is configured to interface with a test scenarios database BDT, which comprises tests T1, T2 and T3 to be carried out for a predetermined fault detection scenario SDP.

In the embodiment described here, each test T1, T2, T3 enables the determination (for example by calculation or measurement) of one or more status data DEₖ.

The first symptoms S¹ᵢ can be obtained from a database BDS which associates at least one first symptom S¹ᵢ with a combination of at least one status data DEₖ. In the example of FIG. 1:
status data DE₁, DE₂ are representative of a first symptom S¹₁;
status data DE₁, DE₃ are representative of a first symptom S¹₂; and
status data DE₂ are representative of a first symptom S¹₃.

The status data DEₖ are, for example, the result of observations made by the operator (smell, part inspection, etc.), the results of measurements made by the on-wing operator, or data obtained by the operator, for example data supplied from an aircraft computer CALC to the terminal TRM via an I/O interface.

In the embodiment described, the system SYS comprises a second module MDS₂ for determining symptoms S²ᵢ, from behaviour data DCₖ representative of a degradation trend in the operation of at least one component of the aircraft.

In the embodiment described here, this second module MDS₂ is a module of the aircraft computer CALC.

In the embodiment described here, at least one symptom S²ᵢ determined by the second symptom determination module MDS₂ consists of a fault signature SIG calculated from behaviour data DCₖ.

More specifically, in the embodiment described here, the second symptom determination module MDS₂ comprises at least one processing module MTᵢ configured to process flight data DV made available by sensors or by electronic systems of the engines or of the aircraft and for setting indicators INDᵢ when they detect behaviour data DCₖ representative of a degradation trend in the operation of at least one component.

Such a processing module MTᵢ is configured, for example, to monitor a trend in flight data over a given period or to detect a pattern in a representation of these flight data.

For example, a processing module MTᵢ sets a first indicator INDᵢ when it detects data DCₖ representative of an increase in pressure or temperature in a component of the aircraft, or more generally when a normality threshold is exceeded by an operating variable of a component of the aircraft.

For example, a processing module MTⱼ sets a second indicator INDⱼ when it detects data DCₖ representative of a particular vibratory phenomenon.

In the embodiment described here, the second symptom determination module MDS₂ generates a signature SIG from these indicators INDᵢ and this signature SIG is processed as a symptom S²ᵢ in the same way as symptoms S¹ᵢ determined by the first symptom determination module MDS₁ from status data DEₖ.

For example, the second symptom determination module MDS₂ includes a logic LOG configured to generate:
a first signature SIG²₁ when the first indicator INDᵢ is set but the indicator INDⱼ is not;
a second signature SIG²₂ when the second indicator INDⱼ is set but the first indicator INDᵢ is not;
a third signature SIG²₃ when the two indicators INDᵢ and INDⱼ are set.

The system SYS comprises a module MDPD for determining the failure probability on the basis of:
first symptoms S¹ᵢ determined from status data DEₖ; and
second symptoms S²ᵢ determined from behaviour data DCₖ.

In the embodiment described here, the module MDPD for determining failure probability uses a Bayesian network RB.

Depending on the presence or absence of first and/or second symptoms, the Bayesian network RB model dynamically updates the probabilities associated with each branch of a decision tree, and thus guides the diagnosis towards identifying the root cause of the fault.

In this way, the symptoms and failures included in the knowledge base constitute the training data for the Bayesian network. The network is trained to predict, during network inference, failures, from symptoms provided as input to the network, for example symptoms determined on-wing.

Over the course of use of the system, the probabilities in the Bayesian network are updated to represent the probability of symptoms causing a given failure and, for each failure, using the associations between symptoms and failures in the knowledge base.

In other words, the Bayesian network learns as it is used and as the knowledge acquired during fault-finding maintenance actions increases.

In the embodiment described here, the failure probability determination module MDPD is integrated into the operator's terminal TRM.

This Bayesian network RB is configured to determine, from the first and second symptoms, the probability of a failure Dⱼ.

For example, a failure Dj may be:
a sensor malfunction; or
a torn harness; or
a software problem.

In the embodiment described here, this Bayesian network RB is trained from a knowledge base BC which comprises records, each of which associates a failure D with at least one symptom S. This knowledge base BC is initialised, for example, from theoretical data derived from the Failure Modes, Effects and Criticality Analysis (FMECA) of the various components.

This knowledge base BC can also be enhanced by feedback from the use of the digital system SYS. For example, if it is detected that combinations of particular first symptoms S¹ᵢ and second symptoms S²ᵢ determined by the computer CAL from behaviour data DCₖ are representative of a failure Dk, the knowledge base BC can be updated with this new learning in order to re-train the Bayesian network RB.

In the embodiment described here, this knowledge base BC comprises records derived from feedback determined by a natural language analysis of documents dealing with actual failure causes.

In the embodiment described here, the various documents available dealing with the actual causes of aircraft failure are analysed by a Natural Language Processing (NLP) module. In the embodiment described here, the system SYS comprises a training module DENT which comprises the natural language processing module MNLP.

These documents include, for example, maintenance or troubleshooting reports, supplied by the airlines. In practice, for a given airline, the number of such reports may be very high, for example several thousand per month. They are usually written in human language: the operator describes a situation and details the corrective actions taken.

Advantageously, the invention enables these reports to be processed automatically, in order to enhance the knowledge base BC of the Bayesian network RB.

In the embodiment described here, the natural language processing module MNLP is configured to receive, as input, unstructured documents DNS and to provide, as output, relevant structured information in the form of labels LABⱼ used to feed the feedback data REX of the knowledge base BC used to train the Bayesian network RB.

In the embodiment described here, the natural language processing module MNLP uses an NLP learning model. As is known, the development of an NLP model essentially consists of:
constructing a learning base starting with the cleaning of input data and ending with the labelling of input data;
implementing the NLP model; and
validating the model NLP from a statistical and experience point of view.

In the context of the invention, the input data to the module MNLP are maintenance report texts and the labels LABⱼ, for each report:
at least one first label representing at least one piece of information from the flight data, status data, behaviour data and/or symptoms; and
at least one second label representing a failure.

In the embodiment described here, the training device DENT of the system SYS comprises a module MEBC for enhancing the knowledge base with at least one record, comprising:
(i) at least one symptom identified from a first label, combined with:
(ii) a failure identified from a second label.

In the embodiment described here, the knowledge base enhancement module MEBC uses:
the symptoms database BDS to identify first symptoms from first labels LABⱼ representative of status data;
the second symptom determination module MDS₂ for identifying second symptoms from first labels LABj representing flight or behaviour data.

For example, with reference to FIG. 1, if the natural language processing module MNLP produces a first label “DE₂” (representing status data) and a second label “D5” (representing a failure) from the unstructured information included in the maintenance reports, the knowledge base enhancement module MEBC:
determines from the third record in the database BDS that status datum DE₂ is representative of a symptom S₃; and
enhances the knowledge base BC with a record that associates symptom S₃ and failure D₅.

Developing an NLP model involves, for example:
constructing a training database that includes the cleaning of input data (management of punctuation, accents, synonyms and antonyms, removal of multiple spaces, transformation of upper case into lower case, etc.);
extracting information (patterns) corresponding to regular expressions;
lemmatisation of the extracted information;
tokenisation;
spelling correction;
removal of stop words).

The system SYS includes a module MSAC configured to signal at least one faulty component among the plurality of aircraft components as a function of the failure probabilities calculated by the module MDPD, and to propose an appropriate corrective action.

The operator can carry out a corrective action Cⱼ proposed by the digital system, to be performed on-wing, for example the removal of a component to be sent to the workshop for analysis and repair.

In the embodiment described here, the module MSAC for signalling a faulty component is integrated into the operator's terminal TRM.

For example, if it is determined by the failure probability determination module MDPD that the most probable failure is sensor wear, the module MSAC can signal to the operator that the sensor is failing and propose a corrective action C₁ to the operator consisting of replacing the sensor.

In one embodiment, the system for determining at least one faulty aircraft component is implemented in a terminal TRM.

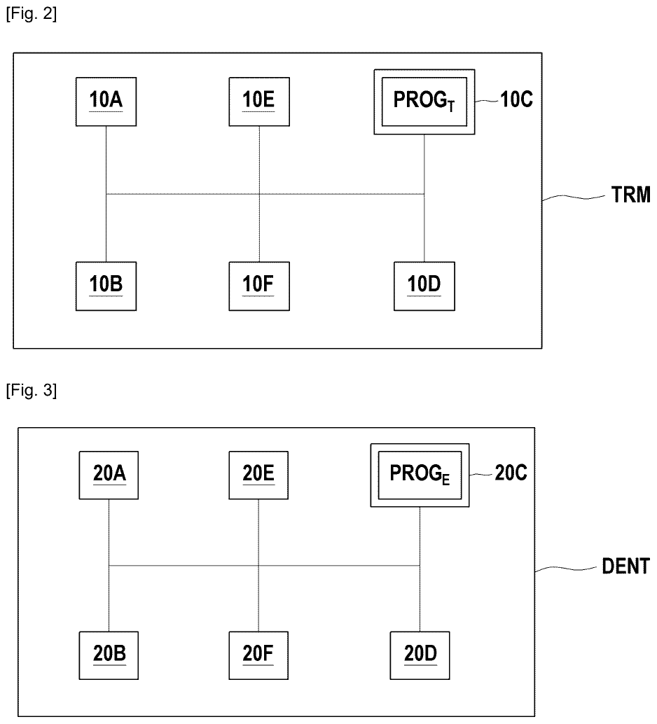

In the embodiment described here, and as shown in FIG. 2, this terminal TRM has the hardware architecture of a computer. It comprises a processor 10A, a random-access memory 10B, a read-only memory 10C, a non-volatile flash memory 10D, input/output means 10E and communication means 10F.

In particular, these communication means 10F enable the terminal TRM 10 to obtain status data DEₖ from the computer CALC of the aircraft, or from externally configured measurement equipment for carrying out on-wing tests.

In one embodiment, these on-wing tests can be carried out by dedicated modules incorporated in the terminal TRM.

In one embodiment, the second module MDS₂ for determining at least one second symptom S²ᵢ is incorporated in the terminal TRM. This module is configured to obtain flight data DV of the aircraft, and to determine at least one fault signature SIG from degradation data DCₖ representative of an abnormal variation in this flight data.

The read-only memory 10C constitutes a recording medium in accordance with the invention, readable by the processor 10A and on which is recorded a computer program PROG_{T} in accordance with the invention, comprising instructions for executing the steps of a method of determining at least one faulty aircraft component in accordance with the invention and which will be described with reference to FIG. 5

This computer program PROG_{T} defines functional and software modules, here configured to implement the steps of the determination method according to the invention. These function modules support or control the hardware elements 10A to 10D of the terminal TRM. They comprise, in particular:
a first module MDS₁ for determining at least one first symptom S¹ᵢ of the aircraft from status data DEₖ collected on-wing;
the second module MDS₂ for determining at least one second symptom S²ᵢ of the aircraft;
a module for determining failure probabilities of a plurality of aircraft components on the basis of said at least one first and second symptoms, this module comprising a Bayesian network RB trained using a knowledge base BC comprising data produced by a natural language processing module configured to process aircraft maintenance reports, and
a module MSAC configured to signal at least one faulty component among said plurality of components as a function of said probabilities.

FIG. 3 shows the hardware architecture of a training device DENT in accordance with the invention. This device has the hardware architecture of a computer and comprises a processor 20A, a random-access memory 20B, a read-only memory 20C, a non-volatile flash memory 20D, input/output means 20E and communication means 20F.

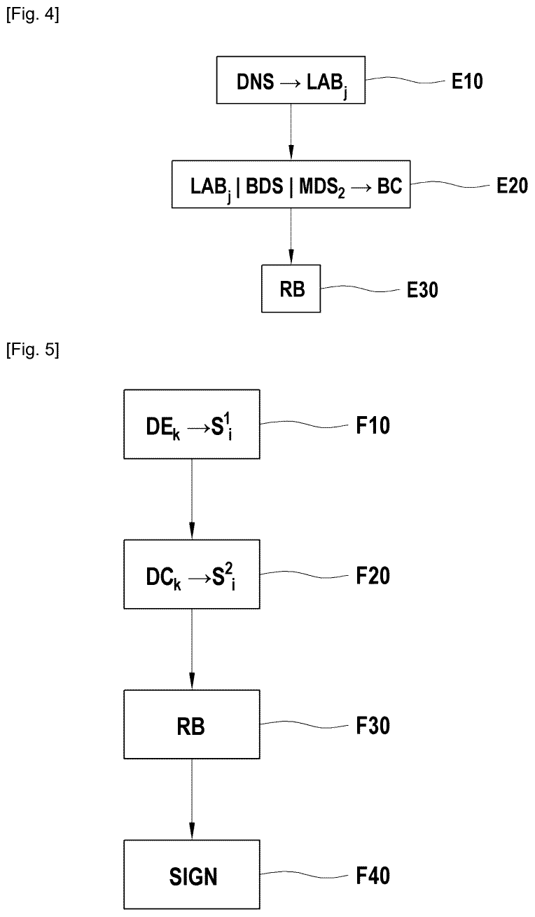

The read-only memory 20C of the training device constitutes a recording medium in accordance with the invention, that can be read by the processor 20A and on which is recorded a computer program PROG_{E} conforming to the invention, comprising instructions for executing the steps of a training method conforming to the invention and which will be described with reference to FIG. 4.

This device DENT is configured to enhance the knowledge base BC used to train the Bayesian network RB used by the module MDPD to determine the failure probabilities of a plurality of aircraft components.

The computer program PROG_{E} defines functional and software modules, configured here to implement the steps of the training method according to the invention. These function modules support or control the hardware elements 20A to 20E of the training device DENT.

In particular, they comprise a natural language processing module MNLP configured to process aircraft maintenance reports DNS and produce structured relevant information IS which feeds the feedback data REX of the knowledge base BC used to train the Bayesian network RB.

In one embodiment of the invention, this structured information consists of:
(i) first labels representing information from flight data, status data, behaviour data and/or symptoms; and
(ii) second labels representing failures.

In the embodiment described here, the functional modules of the device DENT comprise an enhancement module MEBC configured to enhance the knowledge base BC with at least one record comprising:
(i) at least one symptom identified from a first label; combined with
(ii) a failure identified from a second label.

In the embodiment described here, the module MEBC determines at least some of these symptoms using the symptoms database BDS to identify first symptoms from first labels LABⱼ representative of status data and/or the second symptom determination module MDS₂ to identify second symptoms from first labels LABⱼ representative of flight or behaviour data.

FIG. 4 shows the main steps of a training method in accordance with the invention.

It comprises a step E10 of analysing aircraft maintenance reports using a natural language processing method in order to produce data structured in the form of labels LABⱼ.

In the embodiment described here, these labels LABⱼ represent:
information from flight data, status data, behaviour data and/or symptoms; and
failures.

In the embodiment described here, the training method comprises a step E20 to enhance the knowledge base BC of the Bayesian network RB from:
first symptoms determined from labels LABⱼ representing status data and from the symptoms database BDS;
second symptoms determined from labels LABⱼ representing flight or behaviour data and the second module MDS₂ for second symptom determination;
labels LABⱼ representative of failures.

In the embodiment described here, the training method comprises a step E30 of training the Bayesian network RB from this knowledge base so as to update the probabilities of this network in order to improve the root cause fault identification diagnosis using this structured information obtained by NLP processing of the unstructured information contained in the maintenance and troubleshooting reports.

FIG. 5 shows the main steps in a method for determining faulty components in accordance with the invention.

It includes:
a step F10 of determining at least one first symptom S¹ᵢ of the aircraft from status data DEₖ collected on-wing;
a step F20 of determining at least one second symptom S²ᵢ of the aircraft from degradation data DCₖ representative of an abnormal variation of flight data;
a step F30 of determining failure probabilities of a plurality of components of the aircraft from at least one first and second symptom, this determination step using a Bayesian network RB trained using a knowledge base BC comprising data produced by a natural language processing module configured to process aircraft maintenance reports,
a step F40 of signalling at least one faulty component among said plurality of components as a function of said probabilities.

This signalling enables the operator to take corrective action with a high probability that it is actually appropriate to the real cause of the aircraft fault.

1. A digital system for determining at least one faulty component of an aircraft, the system comprising:
a first module for determining at least one first symptom of the aircraft from status data collected on-wing;
a second module for determining at least one second symptom of the aircraft from degradation data representative of an abnormal variation in flight data;
a module for determining failure probabilities of a plurality of components of the aircraft, this module comprising a Bayesian network configured to carry out said determination of probabilities on the basis of said at least one first and second symptoms, said Bayesian network being trained using a knowledge base comprising data produced by a natural language processing module configured to process aircraft maintenance reports,
a module configured to signal at least one faulty component among said plurality of components as a function of said probabilities.

2. The determination system according to claim 1, wherein said natural language processing module takes, as input, texts extracted from said aircraft maintenance reports and produces, as output, labels representing:
information from flight data, status data, behaviour data and/or symptoms; and
failures.

3. The determination system according to claim 1, wherein said at least one second symptom is a signature determined from at least one indicator that is set when the second determination module detects behaviour data representative of a degradation trend in the operation of at least one component of the aircraft.

4. A method of determining at least one faulty component of an aircraft, this computer-implemented method comprising the following steps:
determining at least one first symptom of the aircraft from status data collected on-wing;
determining at least one second symptom of the aircraft from degradation data representative of an abnormal variation in flight data;
determining failure probabilities of a plurality of components of the aircraft on the basis of said at least one first and second symptoms, this determination using a Bayesian network trained using a knowledge base comprising data produced by a natural language processing module configured to process aircraft maintenance reports,
signalling at least one faulty component among said plurality of components as a function of said probabilities.

5. A method for training a Bayesian network intended to be implemented by a module configured to determine failure probabilities of a plurality of components of an aircraft, said determination being carried out by said Bayesian network on the basis of at least one first and at least one second symptom of the aircraft, said Bayesian network being trained on the basis of a knowledge base comprising data produced by a natural language processing module configured to process aircraft maintenance reports, wherein:
said at least one first symptom of the aircraft is determined from status data collected on-wing; and
said at least one second symptom of the aircraft is determined from degradation data representative of an abnormal variation in flight data.

6. A device for training a Bayesian network-intended to be implemented by a module configured to determine failure probabilities of a plurality of components of an aircraft on the basis of at least one first and at least one second symptom of the aircraft, said determination being carried out by said Bayesian network on the basis of at least one first and at least one second symptom of the aircraft, said Bayesian network being trained using a knowledge base comprising data produced by a natural language processing module configured to process aircraft maintenance reports, wherein:
said at least one first symptom of the aircraft is determined from status data collected on-wing; and
said at least one second symptom of the aircraft is determined from degradation data representative of an abnormal variation in flight data.

7. The training device according to claim 6, wherein said natural language processing module takes, as input, texts extracted from said aircraft maintenance reports and produces, as output:
(i) at least one first label representing information concerning flight data, status data, behaviour data and/or symptoms; and
(ii) at least one second label representing a failure,
the training device comprising a module for enhancing the knowledge base with:
(i) at least one symptom identified from a so-called first label, combined with:
(ii) a failure identified from a so-called second label.

8. A non-transitory readable medium comprising a computer program comprising instructions for executing the steps of the method for determining at least one faulty component of an aircraft according to claim 4 when said program is executed by a computer.

9. A non-transitory readable medium comprising a computer program comprising instructions for executing the steps of the training method according to claim 5 when said program is executed by a computer.

10. (canceled)
